(19) United States
(12) Patent Application Publication
(10) Pub. No.: US 2022/0264318 A1
(43) Pub. Date: Aug. 18, 2022

(54) REPORTING FOR MU-MIMO USING BEAM MANAGEMENT

(71) Applicant: Telefonaktiebolaget LM Ericsson (publ), Stockholm (SE)

(72) Inventors: Andreas NILSSON, Göteborg (SE); Sebastian FAXÉR, Stockholm (SE); Mattias FRENNE, Uppsala (SE)

(73) Assignee: Telefonaktiebolaget LM Ericsson (publ), Stockholm (SE)

(21) Appl. No.: 17/610,314

(22) PCT Filed: Sep. 20, 2019
(86) PCT No.: PCT/EP2019/075424

§ 371 Date: Nov. 10, 2021

Related U.S. Application Data
(60) Provisional application No. 62/847,007, filed on May 13, 2019.

(51) Int. Cl. H04W 16/28; H04B 7/06; H04B 17/336; H04B 7/0452

(52) U.S. Cl. CPC H04W 16/28; H04B 7/0695; H04B 7/0452; H04B 17/336; H04B 7/0626

(57) ABSTRACT

A UE receives channel and interference measurement resources, determines one or more throughput values for candidate beam pairs based on power determinations, and reports its beam pair preferences to a node.

### TECHNICAL FIELD

This disclosure relates to apparatuses and methods for multi-user transmissions (e.g., multi-user, multiple-input, multiple-output (MU-MIMO) transmissions). Some aspects of this disclosure relate to apparatuses and methods for reporting, from a UE, preferred beam pairs and/or throughput values and configuring such reporting by a node.

### BACKGROUND

### Beam Management

Narrow beam transmission and reception schemes are typically needed at higher frequencies to compensate for high propagation loss. For a given communication link, a beam can be applied at both the transmit/receive point (TRP) (i.e., an access point, such as a base station, or a component of an access point) and a user equipment (UE), which is often referred to as a beam pair link (BPL) in this disclosure.

A beam management procedure is employed to discover and maintain a TRP 104 beam 112 (e.g., a TRP transmit (TX) beam) and/or a UE 102 beam 116 (e.g., a UE receive (RX) beam). In the example of FIG. 1, one link has been discovered (i.e., the link that consists of TRP beam 112 and UE beam 116) and is being maintained by the network. A BPL is expected to mainly be discovered and monitored by the network using measurements on downlink (DL) reference signals (RSs) used for beam management (e.g., channel-state-information RS (CSI-RS)). The CSI-RS for beam management can be transmitted periodically, semi-persistently, or aperiodic (event triggered), and they can be either shared between multiple UEs or be UE-specific. To find a suitable TRP TX beam, the TRP 104 transmits CSI-RS o different TRP TX beams on which the UE 102 performs reference-signal receive power (RSRP) measurements. Furthermore, the CSI-RS transmission on a given TRP TX beam can be repeated to allow the UE to evaluate suitable UE beams (UE RX beam training).

The large variety of requirements for the next generation of mobile communications system (5G) implies that frequency bands at many different carrier frequencies will be needed. For example, low bands may be needed to achieve sufficient coverage, and higher bands (e.g. mmW, i.e. near and above 30 GHz) may be needed to reach the required capacity. At high frequencies, the propagation properties are more challenging, and beamforming both at the TRP 104 (e.g., a 5G base station (a.k.a., gNB)) and at the UE 102 might be used to reach sufficient link budget.

There are basically three different implementations of beamforming, both at the TRP 104 and at the UE 102: 1) analog beamforming, 2) digital beamforming, and 3) hybrid beamforming. Each implementation has its pros and cons. Digital beamforming is the most flexible solution but also the costliest due to the large number of required radios and baseband chains.

Analog beamforming is the least flexible as it only allows a single beamforming weight applied across the whole bandwidth, but it is cheaper to manufacture due to reduced number of radio and baseband chains and due to the fact that it can be implemented on a time domain signal (as it is wideband). Hybrid beamforming is a compromise between the analog and digital beamforming where a few analog beams are formed and a digital precoder applies across these analog beams. Hence, the analog beamforming network reduces the dimensionality of the digital precoder, thereby reducing the cost, power consumption and complexity. One type of beamforming antenna architecture that has been agreed to study in 3GPP for the New Radio (NR) access technology in 5G is the concept of antenna panels, both at the TRP 104 and at the UE 102. An antenna panel (or “panel” for short) is an antenna array (e.g., a rectangular antenna array) of single-polarized or dual-polarized antenna elements with typically one transmit/receive unit (TX/RU) per polarization. An analog distribution network with phase shifters is used to steer the beam of each panel.

Multiple panels can be stacked next to each other and digital precoding can be performed across the panels, i.e. the same stream of data symbols are transmitted from each panel but with per sub-band phase adjustments to co-phase the transmissions from each panel at the receiver. FIG. 2A illustrates an example of a two two-dimensional dual-polarized panels, FIG. 2B illustrates an example of a two one-dimensional dual-polarized panels, and each panel is connected to one TX/RU per polarization.

At mmW frequencies, concepts for handling mobility between beams (both within and between TRPs) have been specified in NR. At these frequencies, where high-gain beamforming is used, each beam is only optimal to be used within a small geographical area, and the link budget when a terminal moves outside this beam deteriorates quickly. Hence, frequent and fast beam switching may be needed to maintain high performance. Here, switching is used for a system which use fixed beams. An alternative to fixed beams could be adaptive beams that follow the UE movements, and, in this case, the issue is one of tracking instead of switching.

To support such beam switching, a beam indication framework has been specified in NR. For example, for downlink data transmission (PDSCH), the downlink control information (DCI) contains a transmission configuration indicator (TCI) that informs the UE which beam is used so that it can adjust its receive beam accordingly. This is beneficial for the case of analog Rx beamforming, where the UE 102 needs to determine and apply the Rx beamforming weights before it can receive the PDSCH. This is a consequence of the constraint of time domain beamforming, which must be applied on the received signal before fast Fourier transform (FFT) processing and channel estimation.

In what follows, the terminology “spatial filtering weights” or “spatial filtering configuration” refers to the antenna weights that are applied at the transmitter (TRP or UE) and/or the receiver (UE or TRP) for data/control transmission/reception. This terminology is general in the sense that different propagation environments lead to different spatial filtering weights that match the transmission/reception of a signal to the channel. The spatial filtering weights do not in a general case result in a beam in a strict sense, where an ideal beam has one main beam direction and low sidelobes outside this main beam direction.

Prior to data transmission, a training phase is typically required in order to determine the TRP (e.g., gNB) and UE spatial filtering configurations. This is illustrated in FIG. 3 and is referred to in NR as downlink (DL) beam management. In NR, two types of reference signals (RSs) are used for DL beam management operations: (i) the channel state information RS (CSI-RS) and (ii) the synchronization signal/physical broadcast control channel (SS/PBCH) block, or SSB for short. FIGS. 3A-3D show an example where CSI-RS is used to find an appropriate beam pair link (BPL), meaning a suitable gNB transmit spatial filtering configuration (gNB Tx beam) plus a suitable UE receive spatial filtering configuration (UE Rx beam) resulting in sufficiently good link budget. FIG. 3A shows a gNB Tx beam sweep during a beam training phase, FIG. 3B shows a UE Rx beam sweep during the beam training phase, and FIGS. 3C and 3D show downlink and uplink data transmission phases, respectively.

In the example, the beam training phase shown in FIGS. 3A and 3B is followed by the data transmission phase in FIGS. 3C and 3D. During the gNB Tx beam sweep shown in FIG. 3A, the TRP 104 (e.g., gNB) configures the UE 102 to measure on a set of five CSI-RS resources RS1-RS5. The TRP 104 transmits each of the CSI-RS resources RS1-RS5 with a different spatial filtering configuration. That is, the five CSI-RS resources RS1-RS5 are five different Tx beams. The UE 102 is also configured to report back the RS identification (ID) and the reference-signal receive power (RSRP) of the CSI-RS resource corresponding to the maximum measured RSRP. Hence, the RS ID corresponds to a beam, or a certain spatial filter configuration, at the TRP 104.

In the example shown in FIGS. 3A-3D, the UE 102 determined the RS4 as having the maximum measured RSRP. The TRP 104 receives the report from the UE 102 and learns that RS4 is the preferred TX beam from the UE perspective. Typically, TRP 104 selects the spatial transmission configuration that was used to transmit the preferred TX beam from the UE perspective (i.e., RS4 in this example) for future transmissions to the UE 102. As shown in FIG. 3B, to assist the UE 102 in finding a good RX beam, the TRP 104 may perform a subsequent UE Rx beam sweep in which the TRP 104 again transmits a number of CSI-RS resources in different orthogonal frequency division multiplexing (OFDM) symbols but with all CSI-RS resources having the same spatial filtering configuration (i.e., the selected spatial filtering configuration), which in this example is the spatial transmission configuration that was used to transmit RS4 during the gNB Tx beam sweep shown in FIG. 3A.

As shown in FIG. 3B, as the TRP 104 performs a repetition of the same TX beam, the UE 102 then tests a different RX spatial filtering configuration (RX beam) in each OFDM symbol in order to find the RX spatial filter configuration that maximize the received RSRP. In the example, the UE 102 determined RS6 as having the maximum measured RSRP. The UE 102 stores the RS ID of the RX spatial filter configuration that maximize the received RSRP (RS6 in this example) and the preferred RX spatial filter configuration that results in the largest RSRP. The network can then refer to this RS ID in the future when DL data is scheduled to the UE 102, thus allowing the UE 102 to adjust its RX spatial filtering configuration (RX beam) to receive the downlink data transmission (PDSCH). As mentioned above, any RS ID (RS6 in this example) is contained in a transmission configuration indicator (TCI) that is carried in a field in the downlink control information (DCI) that schedules the PDSCH. Hence, that TCI states will be used by the TRP 104 when scheduling PDSCH in subsequent slots and until new beam management measurements finds a better set of TX and RX beams. That is, for downlink data/control transmission shown in FIG. 3C, the TRP 104 (e.g., gNB) indicates to the UE 102 that the Physical Downlink Control Channel (PDCCH)/PDSCH Demodulation Reference Signal (DMRS) (i.e., PDCCH/PDSCH DMRS) is spatially quasi-co-located (QCL) with RS6. At least for the Physical Uplink Control Channel (PUCCH) transmission shown in FIG. 3D, the TRP 104 indicates to the UE 102 that RS6 is the spatial relation for the Physical Uplink Control Channel (PUCCH).

### Spatial QCL Definition

In NR, the term “spatial quasi-co-location” has been adopted and applies to a relationship between the antenna port(s) of two different DL reference signals (RSs). If two transmitted DL RSs are spatially QCL'd at the UE receiver, then the UE 102 may assume that the first and second RSs are transmitted with approximately the same TX spatial filter configuration. Thus, the UE 102 may use approximately the same Rx spatial filter configuration to receive the second reference signal as it used to receive the first reference signal. In this way, spatial QCL basically introduces a “memory,” is a term that assists in the use of analog beamforming, and formalizes the notion of “same UE RX beam” over different time instances.

Referring to the downlink data transmission phase illustrated in FIG. 3C, the TRP 104 (e.g., gNB) indicates to the UE 102 that the PDSCH DMRS is spatially QCL'd with RS6. This means that the UE may use the same RX spatial filtering configuration (RX beam) to receive the PDSCH as the preferred spatial filtering configuration (RX beam) determined based on RS6 during the UE beam sweep in the DL beam management phase (see FIG. 3B).

### Spatial Relation Definition

While spatial QCL refers to a relationship between two different DL RSs from a UE perspective, NR has also adopted the term “spatial relation” to refer to a relationship between an UL RS (e.g., sounding reference signal (SRS) or PUCCH/PUSCH DMRS) and another RS, which can be either a DL RS (e.g., CSI-RS or SSB) or an UL RS (e.g., SRS). This is also defined from a UE perspective. If the UL RS is spatially related to a DL RS, it means that the UE 102 should transmit the UL RS in the opposite direction from which it received the second RS previously. More precisely, the UE 102 should apply the “same” TX spatial filtering configuration for the transmission of the first RS as the Rx spatial filtering configuration it previously used to receive the second RS. If the second RS is an uplink RS, then the UE 102 should apply the same TX spatial filtering configuration for the transmission of the first RS as the TX spatial filtering configuration it used to transmit the second RS previously.

Referring to the uplink data transmission phase illustrated in FIG. 3D, the TRP 104 (e.g., gNB) indicates to the UE 102 that the PUCCH DMRS is spatially related to RS6. This means that the UE should use the “same” TX spatial filtering configuration (TX beam) to transmit the PUCCH as the preferred Rx spatial filtering configuration (RX beam) the UE 102 previously determined based on RS6 during the UE beam sweep in the DL beam management phase shown in FIG. 3B.

Using DL RSs as the source RS in a spatial relation is very effective when the UE 102 has the capability in hardware and software implementation to transmit the UL signal in the same (or one can also see this as “opposite direction” since this is a transmission instead of a reception) direction from which it previously received the DL RS. In other words, using DL RSs as the source RS in a spatial relation is very effective if the UE 102 can achieve the same Tx antenna gain during transmission as the antenna gain it achieved during reception. This capability (known as beam correspondence) will not always be perfect. For example, due to imperfect calibration, the UL TX beam may point in another direction and result in a loss in UL coverage. To improve the performance in this situation, UL beam management based on SRS sweeping (instead of using a DL RS can be used), as shown in FIGS. 4A-4C.

The signaling of the preferred SRS resource as the source of the spatial relation can be performed using different signaling methods (e.g., radio resource control (RRC), medium access control channel element (MAC CE) or downlink control information (DCI)) depending on which channel is pointed to.

To achieve optimum performance, the procedure depicted in FIGS. 4A-4C to update the source RS for a spatial relation should be repeated as soon as the TX beam of the UE 102 changes or if the UE 102 rotates.

The scheduling assignment that triggers the uplink data transmission (PUSCH) in the third step shown in FIG. 4C points to the most recent transmission of the indicated SRS resource. For every subsequent scheduling assignment, the UE 102 is required to use the TX beam used for the corresponding SRS transmission.

FIGS. 4A-4C illustrate uplink (UL) beam management using an SRS sweep. As shown in FIG. 4A, in the first step, the UE 102 transmits a series of UL signals (SRS resources), using different TX beams. The TRP 104 (e.g., gNB) then performs measurements for each of the SRS transmissions, and determines which SRS transmission was received with the best quality, or highest signal quality. As shown in FIG. 4B, the TRP 104 then signals the preferred SRS resource to the UE 102. As shown in FIG. 4C, the UE subsequently transmits the PUSCH in the same beam where it transmitted the preferred SRS resource.

### CSI Feedback in NR

For channel state information (CSI) feedback, NR has adopted an implicit CSI mechanism where a UE 102 feeds back the downlink channel state information, which typically includes a transmission rank indicator (RI), a precoder matrix indicator (PMI), and channel quality indicator (CQI) for each codeword. The CQI/RI/PMI report can be either wideband or sub-band based on configuration.

The RI corresponds to a recommended number of layers that are to be spatially multiplexed and thus transmitted in parallel over the effective channel. The PMI identifies a recommended precoding matrix to use. The CQI represents a recommended modulation level (e.g., quadrature phase shift keying (QPSK), 16 quadrature amplitude modulation (16 QAM), etc.) and coding rate for each codeword or TB. NR supports transmission of one or two codewords to a UE 102 in a slot where two codewords are used for 5 to 8 layer transmission and one codeword is used for 1 to 4 layer transmission. There is thus a relation between a CQI and an signal-to-interference-plus-noise ratio (SINR) of the spatial layers over which the codewords are transmitted, and, for two codewords, there are two CQI values fed back.

### Channel State Information Reference Signals (CSI-RS)

For CSI measurement and feedback, dedicated CSI reference signals (CSI-RS) are defined. A CSI-RS resource consist of between 1 and 32 CSI-RS ports, and each port is typically transmitted on each transmit antenna (or virtual transmit antenna in case the port is precoded and mapped to multiple transmit antennas) and is used by a UE 102 to measure downlink channel between each of the transmit antenna ports and each of its receive antenna ports. The antenna ports are also referred to as CSI-RS ports. The supported number of antenna ports in NR are 1, 2, 4, 8, 12, 16, 24, and 32. By measuring the received CSI-RS, a UE 102 can estimate the channel that the CSI-RS is traversing, including the radio propagation channel, potential precoding or beamforming, and antenna gains. The CSI-RS for the above purpose is also referred to as Non-Zero Power (NZP) CSI-RS, but there are also zero power (ZP) CSI-RS used for purposes other than coherent channel measurements.

CSI-RS can be configured to be transmitted in certain resource elements in a slot and certain slots. FIG. 5 shows an example of a CSI-RS resource mapped to REs for 12 antenna ports, where 1RE per resource block per port is shown.

In addition, interference measurement resource for CSI feedback (CSI-IM) is also defined in NR for a UE 102 to measure interference. A CSI-IM resource contains 4 REs, either 4 adjacent REs in frequency in the same OFDM symbol or 2 by 2 adjacent REs in both time and frequency in a slot. By measuring both the channel based on NZP CSI-RS and the interference based on CSI-IM, a UE 102 can estimate the effective channel and noise plus interference to determine the CSI (e.g., rank, precoding matrix, and the channel quality). Furthermore, a UE 102 in NR may be configured to measure interference based on one or multiple NZP CSI-RS resources.

### CSI Reporting Framework in NR

In NR, a UE 102 can be configured with multiple CSI reporting settings (with higher layer parameter CSI-ReportConfig) and multiple CSI resource settings (with higher layer parameter CSI-ResourceConfig). Each CSI resource setting has an associated identifier (higher layer parameter CSI-ResourceConfigId) and contains a list of S≥1 CSI Resource Sets (given by higher layer parameter csi-RS-ResourceSetList), where the list includes references to NZP CSI-RS resource set(s) or the list includes references to CSI-IM resource set(s). For periodic and semi-persistent CSI Resource Settings, the number of CSI Resource Sets configured is limited to S=1.

For aperiodic CSI reporting, a list of CSI trigger states is configured using the higher layer parameter CSI-AperiodicTriggerStateList. Each trigger state contains at least one CSI report setting. For aperiodic CSI Resource Setting with S>1 CSI resource sets, only one of the aperiodic CSI resource sets is associated with a CSI trigger state, and the UE 102 is higher layer configured per trigger state per Resource Setting to select the one CSI-IM or NZP CSI-RS resource set from the Resource Setting. Downlink control information (DCI) is used to select a CSI trigger state dynamically.

Each CSI reporting setting contains the following information: (i) a CSI resource setting on NZP CSI-RS resources for channel measurement, (ii) a CSI resource setting for CSI-IM resources for interference measurement, (iii) optionally, a CSI resource setting for NZP CSI-RS resources for interference measurement, (iv) time-domain behavior for reporting (e.g., periodic, semi-persistent, or aperiodic reporting), (v) frequency granularity (e.g., wideband or sub-band CQI and PMI respectively), (vi) report quantity, i.e. CSI parameters to be reported such as RI, PMI, CQI, layer indicator (LI) and CSI-RS resource indicator (CRI) in case of multiple NZP CSI-RS resources in a resource set, (vii) codebook types (e.g., type I or II if reported, and codebook subset restriction), and (viii) measurement restriction.

When Kₛ>1 NZP CSI-RS resources are configured in the corresponding NZP CSI-RS resource set for channel measurement, one of the Kₛ>1 NZP CSI-RS resources is selected by the UE 102, and a NZP CSI-RS resource indicator (CRI) is reported by the UE 102 to indicate to the TRP 104 (e.g., gNB) about the selected NZP CSI-RS resource in the resource set. The UE 102 derives the other CSI parameters (i.e., RI, PMI and CQI) conditioned on the reported CRI, where CRI k (k≥0) corresponds to the configured (k+1)-th entry of associated NZP CSI-RS Resource in the corresponding NZP CSI-RS ResourceSet for channel measurement, and (k+1)-th entry of associated CSI-IM Resource in the corresponding CSI-IM-ResourceSet for interference measurement. The CSI-IM-ResourceSet, if configured, has also Kₛ>1 resources.

### Aperiodic CSI-RS

For aperiodic CSI reporting in NR, more than one CSI reporting setting with different NZP CSI-RS resource settings for channel measurement and/or CSI-IM resource settings for interference measurement can be configured within a single CSI trigger state and triggered at the same time with a DCI. In this case, multiple CSI reports, each associated with on CSI report setting, are aggregated and sent from the UE 102 to the TRP 104 (e.g., gNB) in a single PUSCH. Each CSI trigger state can include up to 16 CSI reporting settings in NR. A 3 bit CSI request field in an uplink DCI (e.g., DCI format 0-1) is used to select one of the trigger states for CSI reporting. When the number of radio resource control (RRC) configured CSI trigger states are more than 7, MAC control element (CE) is used to select 7 active trigger states out of the RRC configured trigger states.

Beam management is expected to be based decidedly on aperiodic CSI-RS transmissions because it allows the beam management procedures to be triggered on a per need basis, which facilitate a low overhead consumption.

An aperiodic CSI-RS transmission is triggered by the network by first pre-configuring the UE 102 with a list of aperiodic trigger states in CSI-AperiodicTriggerStateList information element, and, then, whenever a CSI-RS transmission should be carried out, the network signals a codepoint of the DCI field “CSI request” to a UE 102, where each codepoint is associated with one of the pre-configured aperiodic trigger states. Upon reception of the value associated with a trigger state, the UE 102 will perform measurement of the CSI-RSs defined in resourceSet (and if indicated, the CSI-RS(s) defined in csi-IM-ResourcesForinterference or nzp-CSI-RS-ResourcesForinterference) and aperiodic reporting on L1 according to all entries in the associatedReportConfiglnfoList for that trigger state. The CSI-AperiodicTriggerStateList information element is configured using RRC signaling and shown below.

### CSI-AoeriodicTrierStateList Information Element

```
-- ASN1START
-- TAG-CSI-APERIODICTRIGGERSTATELIST-START
CSI-AperiodicTriggerStateList ::= SEQUENCE (SIZE (1..maxNrOfCSI-AperiodicTriggers))
OF CSI-AperiodicTriggerState
CSI-AperiodicTriggerState ::= SEQUENCE {
  associatedReportConfigInfoList SEQUENCE
(SIZE(1..maxNrofReportConfigPerAperiodicTrigger)) OF CSI-AssociatedReportConfigInfo,
  . . .
}
CSI-AssociatedReportConfigInfo ::= SEQUENCE {
```

| | |
|---|---|
| reportConfigId | CSI-ReportConfigId, |
| resourceForChannel | CHOICE { |
| nzp-CSI-RS | SEQUENCE { |
| resourceSet | INTEGER (1..maxNrofNZP-CSI-RS- |
| ResourceSetsPerConfig), | |
| qcl-info | SEQUENCE (SIZE(1..maxNrofAP-CSI-RS-ResourcePerSet)) |
| OF TCI-StateId OPTIONAL | --Cond Aperiodic |
| }, | |
| csi-SSB-ResourceSet | INTEGER (1..maxNrofCSI-SSB-ResourceSetsPerConfig) |
| }, | |

```
  csi-IM-ResourcesForInterference INTEGER(1..maxNrofCSI-IM-ResourceSetsPerConfig)
OPTIONAL -- Cond CSI-IM-ForInteference
  nzp-CSI-RS-ResourceForInterference INTEGER (1..maxNrofNZP-CSI-RS-
ResourceSetsPerConfig) Optional, -- Cond NZP-CSI-RS-ForInterference
  . . .
}
-- TAG-CSI-APERIODICTRIGGERSTATELIST-STOP
```

As shown above, one of the parameters in an aperiodic trigger state is the qcl-info, which contains a list of references to TCI-States for providing the QCL source and QCL type for each NZP-CSI-RS-Resource listed in the NZP-CSI-RS-ResourceSet indicated by nzp-CSI-RS-ResourcesforChannel. For mmWave frequencies, it is expected that the TCI-states indicated in qcl-info contains a spatial QCL reference, and, hence, indicates to the UE 102 which Rx spatial filtering configuration (i.e., UE RX beam) the UE 102 is to use to receive the aperiodic CSI-RS resources.

### MU-MIMO

Multi-user, multiple-input, multiple-output (MU-MIMO) is expected to be a key technical component in 5G. The purpose of MU-MIMO is to enable multiple UE transmissions simultaneously using the same or overlapping time, frequency, and code resource (if any) and, in this way, increase the capacity of the system. If the TRP 104 (e.g., 5G base station (a.k.a., gNB)) has multiple panels, it can perform MU-MIMO transmission by, for example, transmitting to one UE from each panel. Significant capacity gains can be achieved with MU-MIMO if there is low interference between co-scheduled UEs. Low interference can be achieved by making accurate CSI available at the transmitter to facilitate interference nulling in the precoding (mainly applicable for digital arrays) and/or by co-scheduling UEs that have close to orthogonal channels. An example of the latter is if two UEs are in line-of-sight and have an angular separation larger than the beamwidth of the panels. In this case, the two UEs can be co-scheduled by transmitting with a first beam directed to the first UE from a first panel and transmitting with a second beam directed to the second UE from a second panel.

### MU-MIMO with Rel-15 Beam Management Framework

To enable MU-MIMO for analog panels at the TRP 104, it is beneficial that the TRP 104 determines a TRP TX beam for respective UEs 102 which keeps the inter-UE interference low while maintaining a strong signal for each UE 102. In this way, high SIR (or SINR) can be attained for both UEs 102.

One method to select a suitable TRP TX beam using the release 15 (Rel-15) beam management framework is illustrated in FIG. 6A. In FIG. 6A, the TRP 104 has determined two UEs 102a and 102b that it would like to co-schedule in the DL direction. Therefore, the TRP 104 would like to find suitable TRP TX beams for both UEs 102a and 102b.

In a first step, the TRP 104 performs a TRP TX beam sweep A, which means that the TRP 104 transmits CSI-RS resources using a set 601 of four different TRP TX beams roughly pointing in a direction towards UE 102a (the approximate direction of each UE can be obtained for example based on UE reports of the strongest Synchronization Signal Block (SSB) beam). Both UEs 102a and 102b are triggered to perform RSRP measurements on the CSI-RS resources of TRP TX beam sweep A and report the RSRP for each respective TRP TX beam. Here, the RSRP should preferably be as high as possible for UE 102a and as low as possible for UE 102b (because it will be considered as interference for UE 102b) in order to maximize the MU-MIMO performance.

In the second step, the same thing is done again, except that a new set of TRP TX beams 603 are use during the CSI-RS transmission, where the new set 603 of TRP TX beams point roughly in the direction of UE 102b. Again, both UEs 102a and 102b report RSRP for all four TRP TX beams. The TRP 104 now has access to received signal strength for both UEs 102a and 102b from all 8 TRP TX beams.

In a third step, the TRP 104 evaluates the SIR for all 16 different combinations of TRP TX beam pairs (where each combination consists of one TRP TX beam from beam sweep A to be used for transmission to UE 102a and one TRP TX beam from beam sweep B to be used for transmission to UE 102b). The TRP 104 can then select the TRP TX beam combination that, for example, maximizes the average SIR over both UEs 102a and 102b, as shown in FIG. 6B.

### UE Implementation at mmWave

For UEs 102, the incoming signals can arrive from any direction, hence it is beneficial and typical to have an antenna implementation at the UE 102 having the possibility to generate omni-directional-like coverage in addition to the high gain narrow beams. Still, array gain is crucial for coverage, hence panels of antenna arrays are typically used. One way to increase the omni-directional coverage at a UE 102 is then to install multiple panels and point the panels in different directions. FIG. 7 illustrates a UE 702 having multiple panels pointed in different directions.

### SUMMARY

According to embodiments, a method is provided for selection and reporting of TRP beam pairs. The method comprises: producing a first power value based on a reception of a first measurement resource transmitted using a first TRP beam; producing a second power value based on a reception of a second measurement resource transmitted using a second TRP beam; determining a first throughput value (e.g., SIR, SINR, etc.) using as inputs the first and second power values; and using the first throughput value in a process for selecting N TRP beam pairs from a set of candidate beam pairs, wherein said set of candidate beam pairs includes said first and second TRP beams, and wherein N is a predetermined whole number. In some embodiments, a UE is provided, wherein the UE is adapted to perform the method. The UE may comprise, for instance, a memory and a processor, wherein the processor is configured to perform the method. Some embodiments provide a computer program comprising instructions that when executed by processing circuitry of a UE, cause the UE to perform the method. The computer program may be contained on a carrier, wherein the carrier is one of an electronic signal, an optical signal, a radio signal, and a computer readable storage medium.

According to embodiments, a method for reporting is provided. The method comprises: receiving, at a user equipment (UE), a plurality of measurement resources, wherein said plurality of measurement resources comprises at least one channel measurement resource (CMR) from a first TRP beam and at least one interference measurement resource (IMR) from a second TRP beam; calculating one or more throughput values (e.g., SIR, SINR, etc.), based on said plurality of measurement resources, wherein each throughput value corresponds to a transmit beam pair (i.e., TRP channel/interference TX beam combination); and reporting, to a node, one or more transmission beam pair indicators based on said calculated throughput values. In some embodiments, a UE is provided, wherein the UE is adapted to perform the method. The UE may comprise, for instance, a memory and a processor, wherein the processor is configured to perform the method. Some embodiments provide a computer program comprising instructions that when executed by processing circuitry of a UE, cause the UE to perform the method. The computer program may be contained on a carrier, wherein the carrier is one of an electronic signal, an optical signal, a radio signal, and a computer readable storage medium.

According to embodiments, a method is provided that comprises: configuring a user equipment (UE) for a TRP TX beam sweep; transmitting a first measurement resource using a first TRP beam and a second measurement resource using a second TRP beam to said UE; and receiving, from said UE, one or more transmission beam pair indicators, wherein said beam pair indicators are selected by said UE based on one or more throughput values corresponding to said first and second TRP beams. In some embodiments, a node (e.g., TRP) is provided, wherein the node is adapted to perform the method. The node may comprise, for instance, a memory and a processor, wherein the processor is configured to perform the method. Some embodiments provide a computer program comprising instructions that when executed by processing circuitry of a node, cause the node to perform the method. The computer program may be contained on a carrier, wherein the carrier is one of an electronic signal, an optical signal, a radio signal, and a computer readable storage medium.

According to embodiments, a method is provided for reporting a preferred transmission hypothesis indication from a UE, where: (1) the preferred transmission hypothesis indication comprises an indication of at least one channel measurement resource (CMR) and at least one interference measurement resource (IMR), (2) the CMR and IMR are non-zero power (NZP) reference signals, and (3) the UE reports the preferred transmission hypothesis to a network node. In some embodiments, the UE reports SIR for the indicated transmission hypothesis, and the UE can calculate the SIR by applying receiver antenna weights, assuming PDSCH transmission. In some embodiments, the UE obtains a configuration of a plurality of aperiodic trigger states, wherein each aperiodic trigger state is associated with of a set of CMRs and a set of IMRs. Thus, the method may include receiving a downlink control information signal indicating a triggered aperiodic trigger state from the plurality of aperiodic trigger states, and measuring the set of CMRs and the set of IMRs associated with the triggered aperiodic trigger state. In some embodiments, a UE is provided, wherein the UE is adapted to perform the method. The UE may comprise, for instance, a memory and a processor, wherein the processor is configured to perform the method. Some embodiments provide a computer program comprising instructions that when executed by processing circuitry of a UE, cause the UE to perform the method. The computer program may be contained on a carrier, wherein the carrier is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 illustrates a wireless communication system.

FIGS. 2A and 2B illustrate examples with two-dimensional dual-polarized panels.

FIGS. 3A-3D illustrate example beam sweeps and data transmission.

FIGS. 4A-4C illustrate example beam management using an SRS sweep.

FIG. 5 illustrates an example of resource element allocation.

FIG. 6A illustrates an example of selection of a TRP TX beam using the release 15 (Rel-15) beam management framework.

FIG. 6B illustrates an example of a TRP using two TRP TX beams to communicate with two UEs simultaneously.

FIG. 7 illustrates a UE with at least two panels.

FIG. 8 illustrates an example of a TRP performing two TRP TX beam sweeps.

FIG. 9 illustrates an example of a TRP using two TRP TX beams to communicate with two UEs simultaneously.

FIG. 10 is a flow chart illustrating a process according to embodiments.

FIG. 11A illustrates a wireless communication system according to embodiments.

FIG. 11B illustrates a beam pair index according to embodiments.

FIG. 12 illustrates a wireless communication system according to embodiments

FIG. 13 is a flow chart illustrating a process according to embodiments.

FIG. 14 is a flow chart illustrating a process according to embodiments.

FIG. 15 is a flow chart illustrating a process according to embodiments.

FIG. 16 is a diagram of a user equipment (UE) according to embodiments.

FIG. 17 is a diagram of a user equipment (UE) according to embodiments.

FIGS. 18A-18C are illustrations of signaling relating to receive spatial filters according to some embodiments.

FIG. 19 schematically illustrates a telecommunication network connected via an intermediate network to a host computer.

FIG. 20 is a generalized block diagram of a host computer communicating via a base station with a user equipment over a partially wireless connection.

FIG. 21 is a flowchart illustrating a method implemented in a communication system including a host computer, a base station and a user equipment.

FIG. 22 is a flowchart illustrating a method implemented in a communication system including a host computer, a base station and a user equipment.

FIG. 23 is a flowchart illustrating a method implemented in a communication system including a host computer, a base station and a user equipment.

FIG. 24 is a flowchart illustrating a method implemented in a communication system including a host computer, a base station and a user equipment.

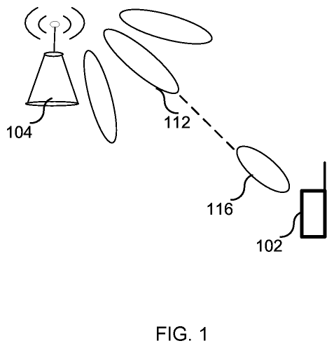

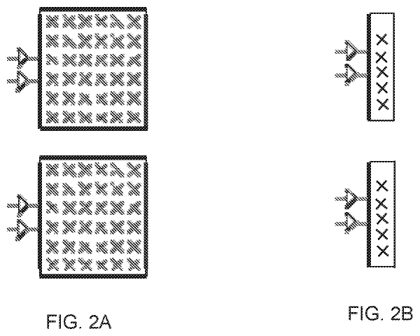

### DETAILED DESCRIPTION

According to embodiments, a new measurement resource (e.g., CSI-RS) reporting configuration and process is introduced, which indicates to one or more UEs that they should report the N best TRP Tx beam pairs and/or and their corresponding throughput values (e.g., SIR, SINR, etc.). For instance, a UE can report back to a node, after measurement of each TRP TX beam of a sweep, an indication of a preferred TX pair that identifies one TRP TX beam from a CSI-RS resource set used for channel measurements, and one TRP TX beam from a CSI-RS resource set used for interference measurements. By enabling UEs to evaluate TRP TX beam pairs, and report optimal pairings and/or corresponding throughput values, certain limitations of existing processes may be overcome. Improved performance in the system can be achieved since the TRP can make more reliable decisions when scheduling, for example, users for MU-MIMO.

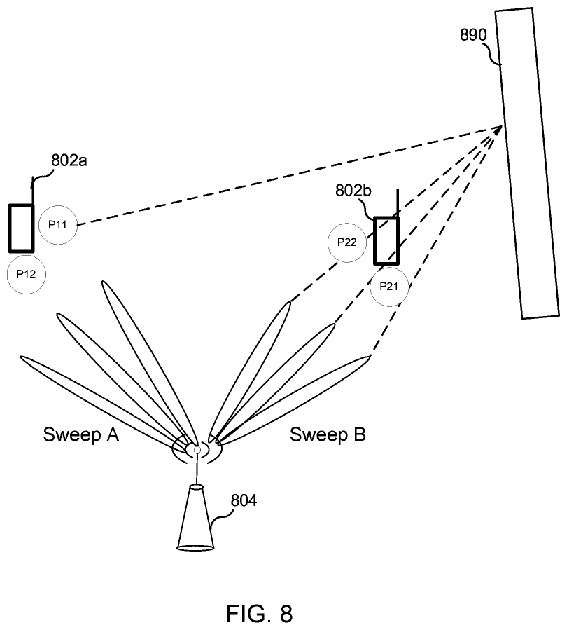

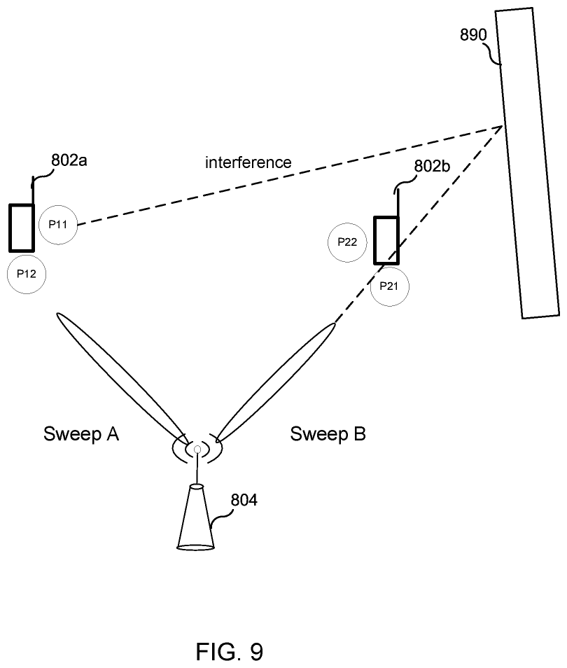

For example, and referring now to FIGS. 8 and 9, there is a problem associated with finding appropriate scheduling candidates for MU-MIMO scheduling in an environment with scattering and with multi-panel UEs, as the integrity of the “beam” generally does not hold in such environment. In particular, FIGS. 8 and 9 illustrate an example of a problem associated with the Rel-15 downlink beam management solution for MU-MIMO described above. In this example, there are two UEs (UE 802a and UE 802b). Each of the UEs 802a and 802b has two antenna arrangements (e.g., panels P11 and P12 for UE 802a, and panels P21 and P22 for UE 802b). The antenna arrangements for each UE are pointing in different directions. As illustrated in FIG. 8, during the TRP TX beam sweep B, both UE 802a and UE 802b will report strong RSRP for all three TRP TX beams, because there is a reflection in a wall 890 that creates a strong path between the TRP TX beams in TRP TX beam sweep B and the panel Pll of UE 802a. This means that both UEs 802a and 802b will report strong RSRP values for all TRP TX beams in TRP TX beam sweep B. Hence, the TRP 804 will assume that it is not possible to co-schedule the two UEs 802a and 802b (e.g., not possible to schedule the two UEs 802a and 802b for MU-MIMO transmission).

However, as can be seen in FIG. 9, it would be possible to co-schedule the two UEs 802a and 802b because the best TRP TX beam from TRP TX beam sweep A will be received mainly with antenna/panel P12 of UE 702a, while the interference from the best TRP TX beam from TRP TX beam sweep B will be received mainly with antenna/panel P11 of UE 702a. Accordingly, it is easy for UE 702a to remove the interference and attain a good signal to inference measure (SIM) (e.g., good SIR or SINR) with just a simple interference rejection combining (IRC) receiver), which can be assumed to be available at UEs with multiple receiver antenna/panels (or, in a more simple case, by only receiving with the panel without the strong interference).

Thus, the example illustrated in FIGS. 8-9 shows that, with the Rel-15 downlink beam management for MU-MIMO, it can be difficult to determine if two UEs can be co-scheduled, and determining the best TRP TX beams is difficult because it is not clear with which panels of the UE are receiving the different TRP TX beams. With the reporting of disclosed embodiments, the node can now receive improved information from UEs, which can in turn improve co-scheduling and beam selection.

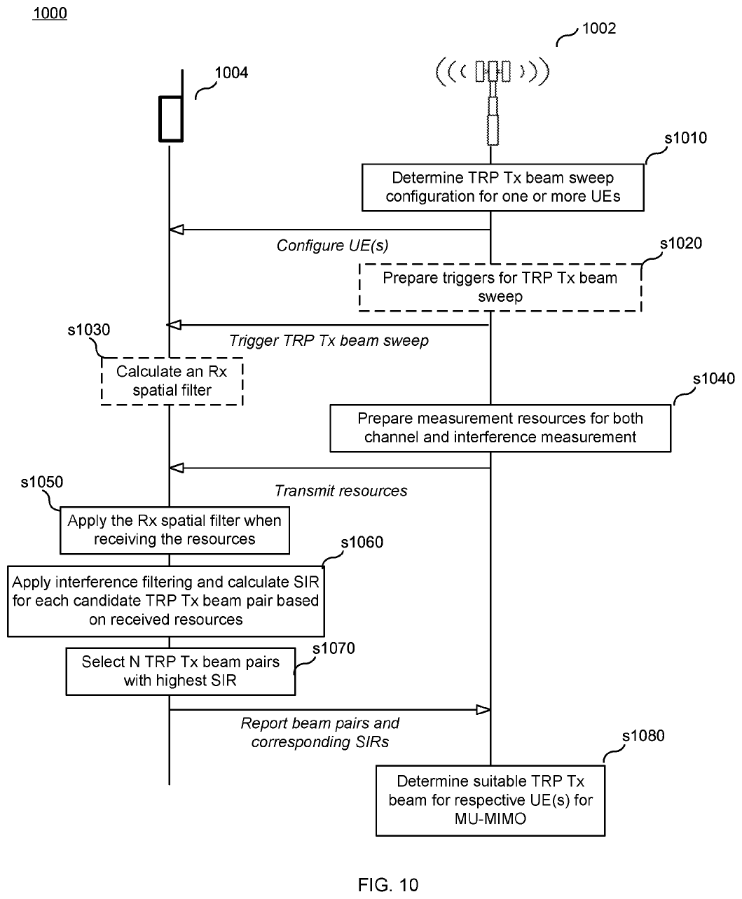

Referring now to FIG. 10, a flow diagram is provided illustrating a process 1000 according to some embodiments. In this example, the process 1000 may be performed by a TRP node 1002 and a UE 1004. Although the process is illustrated for one UE, it can be applied simultaneously for multiple UEs in order to maximize the benefits of MU-MIMO scheduling.

In the first step of the process 1010, the TRP 1002 configures a UE 1004 with a TRP TX beam sweep, for example, as part of a beam sweep, beam selection, and measurement resource setup for MU-MIMO. This may include determining a TRP beam sweep configuration and communicating the configuration to the UE 1004, for instance, via RRC signaling. In some instances, this may be performed as part of the initial attach between the UE 1004 and node 1002.

According to some embodiments, the configuration is aperiodic. In this case, configuring 1010 may include configuring the UE 1004 with a CSI-AperiodicTriggerStateList with a trigger state that indicates two CSI-RS resource sets, where a first NZP CSI-RS resource set should be used by the UE for channel measurements, and a second CSI-RS resource set should be used by the UE for interference measurements. The signaling may be, for example, RRC signaling or MAC CE signaling, and contain configuration of two sets per trigger state. In the case of aperiodic triggers, the node 1002 may prepare triggers 1020 for the TRP beam sweep and signal them to UE 1004.

In some embodiments, the process 1000 may include the step of the UE calculating 1030 a spatial RX filter to be used during the TRP TX beam sweep. In certain aspects, report setting may also indicate that the UE should receive the resources for both the channel measurement set and the interference measurement set using the same receiver filter as the UE would use during PDSCH reception.

In some embodiment, periodic or semi-persistent beam sweeps may be used. In this case, the corresponding NZP CSI-RS resource sets are referred to in the CSI-ResourceSetting linked for channel measurement and interference measurement, respectively.

Referring now to step 1040, the TRP node 1002 prepares and transmits measurement resources for both the channel and interference measurements to UE 1004. In certain aspects, the measurement resources are CSI-RS resources for the TRP TX beam sweep. For instance, the node 1002 may transmit both the CSI-RS resource belonging to the CSI-RS resource set intended for channel measurements and the CSI-RS resources belonging to the CSI-RS resource set intended for interference measurements. In some embodiments, to save overhead, the TRP node 1002 transmits the CSI-RS resources from both sets simultaneously from two different TRP TX panels. For embodiments where the process 1000 is applied for two UEs, for example in the arrangement illustrated in FIGS. 8 and 9, both UEs can perform measurements on the same CSI-RS resources to reduce the overhead even further. In that case, the CSI-RS resources that are used for channel measurements for one UE would be used for interference measurements by the second UE, and vice versa.

In step 1050 of process 1000, the UE 1004 applies an RX spatial filter, e.g., the filter calculated in step 1030, when receiving the measurement resources belonging to the TRP TX beam sweep.

In the next step 1060, the UE 1004 applies interference filtering and determines throughput values for each candidate beam pair. That is, the UE 1004 calculates a throughput value for each TRP (channel/interference) TX beam combination. For instance, if there are 4 CSI-RS resources in each of the two CSI-RS sets, there would be 16 possible combinations, since each CSI-RS resource in the first CSI-RS set can be combined with one CSI-RS resource in the second CSI-RS set.

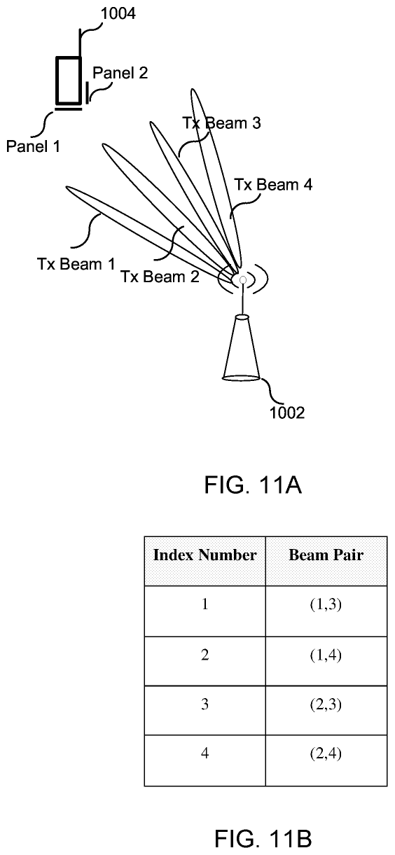

By way of further example, candidate beam pairs may also be illustrated with respect to the diagram of FIG. 11A. In FIG. 11A, UE 1004 receives measurement resources on antenna panels 1 and 2, from channel transmit beams 1 and 2 and interference transmit beams 3 and 4 of the TRP node 102 (e.g., where beams 3 and 4 would be intended for a second UE). Thus, in this example, there would be 4 beam pairs that the UE could consider:
1. Tx Beam 1 (channel) with TX Beam 3 (interference)
2. Tx Beam 1 (channel) with TX Beam 4 (interference)
3. Tx Beam 2 (channel) with TX Beam 3 (interference)
4. Tx Beam 2 (channel) with TX Beam 4 (interference)

According to some embodiments, the UE 1004 is configured to evaluate all TRP TX beam combinations, including where a beam combination includes a combination of two TRP TX beams providing channel measurement resources, or a combination of two TRP TX beams providing interference measurements. In this instance, there would be at least 6 beam pairs that the UE could consider:
1. Tx Beam 1 (channel) with TX Beam 3 (interference)
2. Tx Beam 1 (channel) with TX Beam 4 (interference)
3. Tx Beam 2 (channel) with TX Beam 3 (interference)
4. Tx Beam 2 (channel) with TX Beam 4 (interference)
5. Tx Beam 1 (channel) with TX Beam 2 (channel)
6. Tx Beam 3 (interference) with TX Beam 4 (interference)

According to some embodiments, the UE 1004 may calculate throughput values (e.g., SIR, SINR, etc.) for all of the TX beam pairs (channel-interference). The UE 1004 may then report all results, or alternatively, report only the best N beam combinations.

Alternatively, the UE 1004 may calculate values for only a subset N of the possible TRP TX beam pairs, where N ranges from zero to all pairs. The value of N may be, for example, according to a pre-defined rule. For instance, if the NZP CSI-RS resource set for channel measurement contains 2 CSI-RS resources and the NZP CSI-RS resource set for interference measurement contains 4 CSI-RS resources, the predefine rule may be such that the combinations (0,0), (0,1), (1,2), (1,3) comprise the said subset. That is, the CSI-RS resources for interference measurement are divided equally between the two CSI-RS resources for channel measurement. In another alternative, the subset of possible TRP (channel-interference) TX beams may be defined by higher layer signaling as part of the configuration of the CSI report. For instance, if there are 16 possible combinations, a bitmap of size 16 may be signaled to define the subset, where a ‘1’ indicates that the combination is included in the subset.

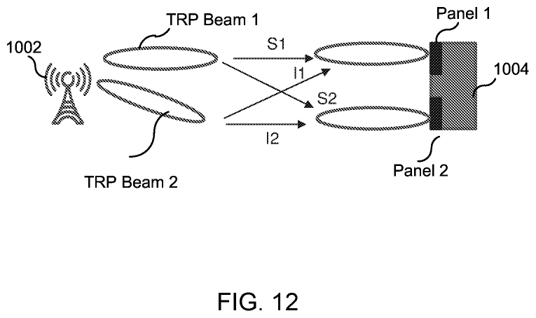

According to embodiments, the determination of the throughput value comprises the application of interference processing. Such interference processing may include, for instance, determining one or more weights for the first and second panels of UE 1004. For example, and referring now to FIG. 12, the UE may determine a first weight a1 and second weight a2 that maximize total estimated SIR according to the following:

SIR_Total=a1*SIR_UE_Panel_1+a2*SIR_UE_Panel_2

where

SIR_UE_Panel_1=S1/I1

SIR_UE_Panel_2=S2/I2

and solving the following maximization equation:

max(a1*SIR_UE_Panel_1+a2*SIR_UE_Panel_2)

while a1+a2=1. As illustrated in FIG. 12, S1 is measured power of the channel resource of TRP beam 1 on a first panel; I1 is the measured power of the interference resource from TRP beam 2 measured on the first panel; S2 is the measured power of the channel resource of TRP beam 1 on a second panel; and I2 is the measured power of the interference resource from TRP beam 2 on the second panel. According to embodiments, a1 and a2 have a value of either 1 or 0. This may correspond, in some cases, to the a scenario where the UE 1004 anticipates reception primarily on only one panel during subsequent data transmission. Interference processing may not be limited to this example, and can include any weighting or calculation scheme compatible with the UE 1004 interference rejection combining (IRC) receiver. In certain aspects, the a1 and a2 values will only be used during the SIR/SINR estimations for the TRP TX beam sweep. During a subsequent data transmission, the actual data channel will be known by the UE 1004, and it can estimate an interference covariance matrix which then can be used to determine an IRC filter or similar interference cancelation application.

In some embodiments, determining the throughput value can include comparing the SIR (or SINR, etc.) values for each of the two panels on UE 1004. For instance, the reported SIR (and selection of the beam pair) can be based on the higher of the two SIR values (or other throughput values).

In the next step 1070, the UE 1004 selects N TRP beam pairs and signals the selection back to the TRP. For example, the UE 1004 may select the N TRP (channel-interference) TX beam pairs with the highest throughput values (e.g., SIRs, SINRs, etc.). A set forth above, the value of N may be pre-defined in the specification, or, configurable via higher-layer signaling such as RRC signaling, for instance comprised in the CSI report configuration. Or, the value of N may be determined and reported by the UE 1004. Additionally, the UE 1004 may report the corresponding throughput values with the selected beam pairs, or just the throughput values.

In some embodiments, the UE signals back a transmission hypothesis indicator where the indication for the preferred resource for channel measurement and the preferred resource for interference measurement is jointly encoded into a single index instead of transmitting a set of two CRI values. An example index is illustrated in FIG. 11B. This may be beneficial in the sense that it may reduce signaling overhead in the case where the number of resources in the sets is not a power of two. It also reduces overhead in case where only a subset of the possible combinations can be reported.

In the last step 1080 of process 1000, the TRP node 1002 evaluates whether there are any suitable TRP TX beam pairs that could be used for MU-MIMO transmission for two or more UEs.

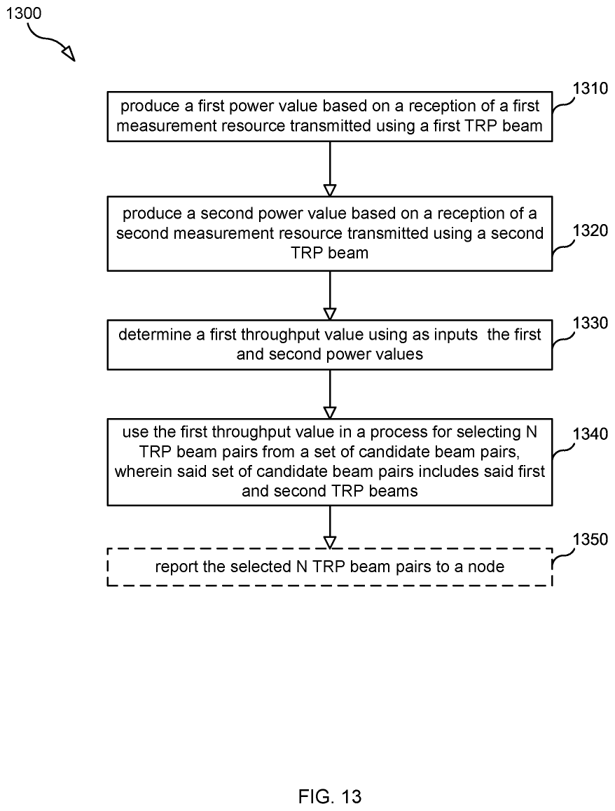

Referring now to FIG. 13, a process 1300 is provided according to some embodiments. The process may be performed, for instance, by UE 1004. Process 1300 may begin with step 1310.

Step 1310 comprises producing a first power value based on a reception of a first measurement resource transmitted using a first TRP beam.

Step 1320 comprises producing a second power value based on a reception of a second measurement resource transmitted using a second TRP beam.

Step 1330 comprises determining a first throughput value using as inputs the first and second power values. In some embodiments, the first measurement resource is a channel measurement resource and the second measurement resource is an interference measurement resource. The UE 1004 may have at least two panels, and both said first and second power values can be produced based on power measurements of signals received on the same panel (e.g., a first panel).

In some embodiments, the method comprises producing a third power value based on a reception of the first measurement resource on a second panel of the UE; and producing a fourth power value based on a reception of the second measurement on the second panel of the UE. Further, determining the first throughput value may comprise calculating a first SIR based on the first and second power values, and calculating a second SIR based on the third and fourth power values. The reported throughput value can be a weighted sum of the first and second SIRs. In some embodiments, determining the throughput value comprises comparing the first and second SIRs, and in some instances, the first throughput value is just the larger of the two.

Step 1340 comprises using the first throughput value in a process for selecting N TRP beam pairs from a set of candidate beam pairs, wherein the set of candidate beam pairs includes the first and second TRP beams. In some embodiments, selecting N TRP beam pairs comprises selecting the beam pair having the highest throughput value.

In some embodiments, process 1300 also includes step 1350, which comprises reporting the selected N TRP beam pairs to a node, which may further comprise reporting the corresponding throughput values. In some embodiments, the N TRP beam pairs are each reported using an index value.

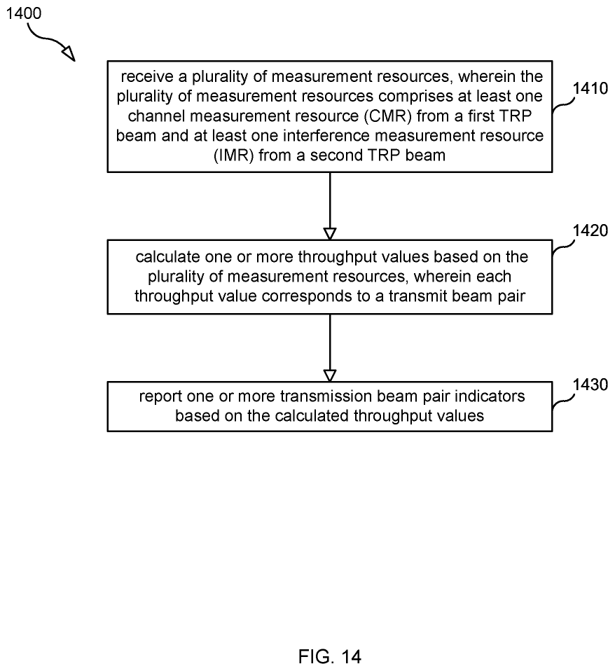

Referring now to FIG. 14, a process 1400 is provided according to some embodiment. The process may be performed, for instance, by UE 1004. Process 1400 may begin with step 1410.

Step 1410 comprises receiving a plurality of measurement resources, wherein the plurality of measurement resources comprises at least one channel measurement resource (CMR) from a first TRP beam and at least one interference measurement resource (IMR) from a second TRP beam.

Step 1420 comprises calculating one or more throughput values based on the plurality of measurement resources, wherein each throughput value corresponds to a transmit beam pair. In some embodiments, calculating throughput values is performed for all pairs, in some embodiments it is performed for as sub-set of measurement resources received from the set of TRP beams, wherein the sub-set is determined according to a predefined rule (e.g., pre-defined in the specification, configured via RRC signaling, determined by UE 1004).

Step 1430 comprises reporting one or more transmission beam pair indicators based on the calculated throughput values. According to embodiments, the one or more transmission beam pair indicators identify the UE's preferred transmission beam pair (e.g., the beam pairs with the highest calculated throughput value). Additionally, the reported transmission beam pair indicators can comprise at least one throughput value and an identification of the TRP transmit beams corresponding to the measurement resources used to calculate the throughput value. The identification can be an index value.

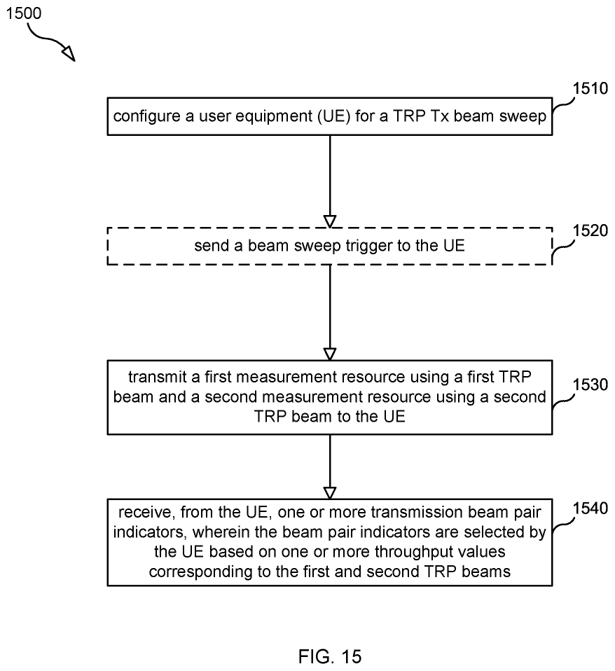

Referring now to FIG. 15, a process 1500 is provided according to some embodiments. The process may be performed, for instance, by TRP node 1002. Process 1500 may begin with step 1510.

Step 1510 comprises configuring a user equipment (UE) for a TRP Tx beam sweep.

In some embodiments, the process 1500 includes step 1520, which comprises sending a beam sweep trigger to the UE. The can trigger indicate a trigger state having a resource set for channel measurement and a resource set for interference measurement.

Step 1530 comprises transmitting a first measurement resource using a first TRP beam and a second measurement resource using a second TRP beam to the UE.

Step 1540 comprises receiving, from the UE, one or more transmission beam pair indicators, wherein the beam pair indicators are selected by the UE based on one or more throughput values corresponding to the first and second TRP beams. In some instances, the received beam pair indicator further comprises the throughput values themselves.

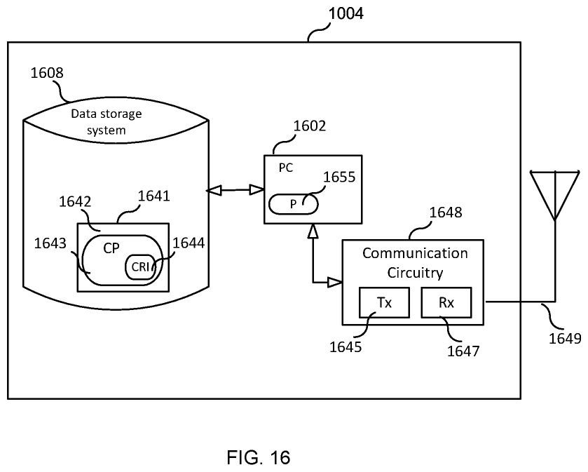

FIG. 16 is a block diagram of UE 1004, according to some embodiments. As shown in FIG. 16, UE 1004 may comprise: processing circuitry (PC) 1602, which may include one or more processors (P) 1655 (e.g., one or more general purpose microprocessors and/or one or more other processors, such as an application specific integrated circuit (ASIC), field-programmable gate arrays (FPGAs), and the like); communication circuitry 1648, which is coupled to an antenna arrangement 1649 comprising one or more antennas and which comprises a transmitter (Tx) 1645 and a receiver (Rx) 1647 for enabling UE 1004 to transmit data and receive data (e.g., wirelessly transmit/receive data); and a local storage unit (a.k.a., “data storage system”) 1608, which may include one or more non-volatile storage devices and/or one or more volatile storage devices. In embodiments where PC 1602 includes a programmable processor, a computer program product (CPP) 841 may be provided. CPP 1641 includes a computer readable medium (CRM) 1642 storing a computer program (CP) 1643 comprising computer readable instructions (CRI) 1644. CRM 1642 may be a non-transitory computer readable medium, such as, magnetic media (e.g., a hard disk), optical media, memory devices (e.g., random access memory, flash memory), and the like. In some embodiments, the CRI 1644 of computer program 1643 is configured such that when executed by PC 1602, the CRI causes UE 1004 to perform steps described herein (e.g., steps described herein with reference to the flow charts). In other embodiments, UE 1004 may be configured to perform steps described herein without the need for code. That is, for example, PC 1602 may consist merely of one or more ASICs. Hence, the features of the embodiments described herein may be implemented in hardware and/or software. According to embodiments, a TRP node 1002 may comprise similar components.

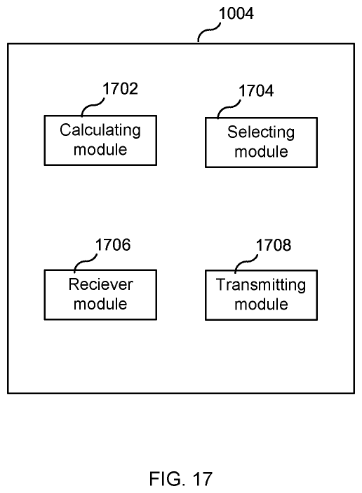

FIG. 17 is a schematic block diagram of UE 1004 according to some other embodiments. UE 1004 in some embodiments includes one or more modules, each of which is implemented in software. The module(s) provide the functionality described herein (e.g., the steps herein, e.g., with respect to FIGS. 10, 13, and 14). In one embodiment, the modules include: a receiver module 1706 adapted to receive measurement resources and produce one or more power values based on the reception of the resources; a calculating module 1702 adapted to calculate one or more throughput values (e.g., SIR, SINR, etc.) using the one or more power values; a selecting module 1704 adapted to select N TRP beam pairs from a set of candidate beam pairs; and a transmitting module 1708 adapted to report the selected N TRP beam pairs and/or the corresponding throughput values, for instance, to TRP node 1002.

According to some embodiments, a UE 1004 may use a pre-determined or otherwise known RX spatial filter. For example, the UE 1004 may use a wideband spatial filter for both a first and second panel. In alternative embodiments, a UE 1004 may determine an RX spatial filter.

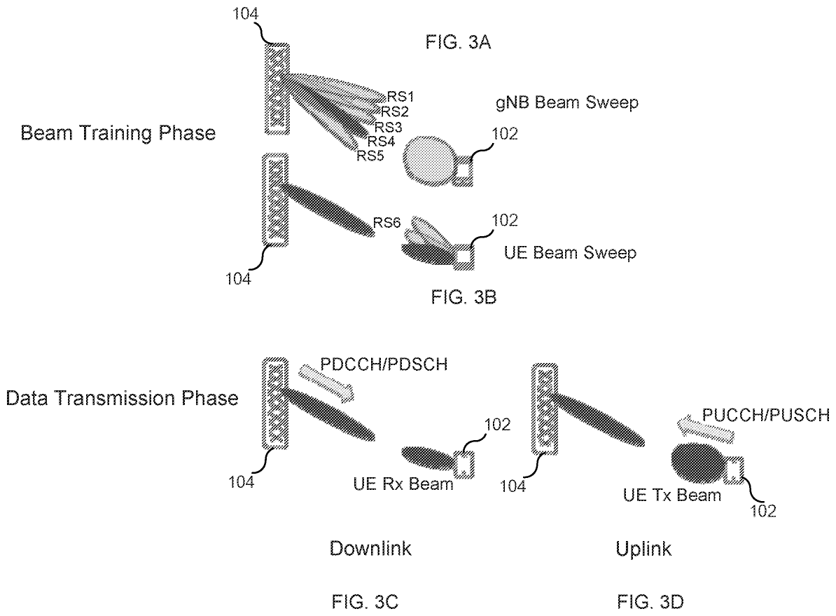

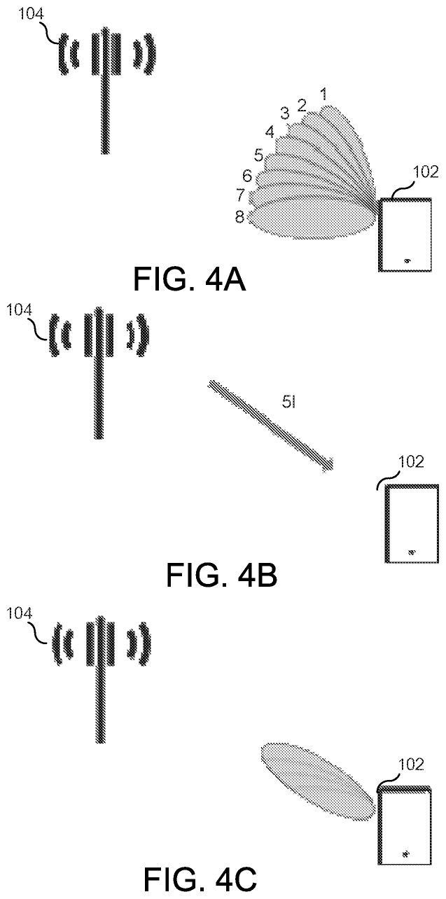

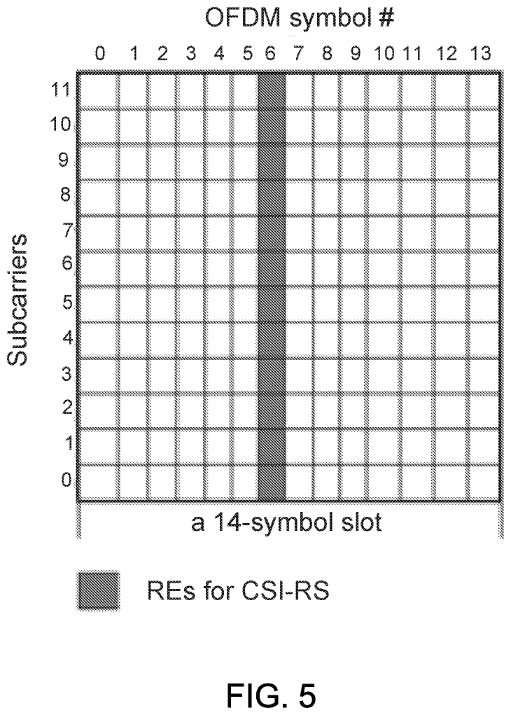

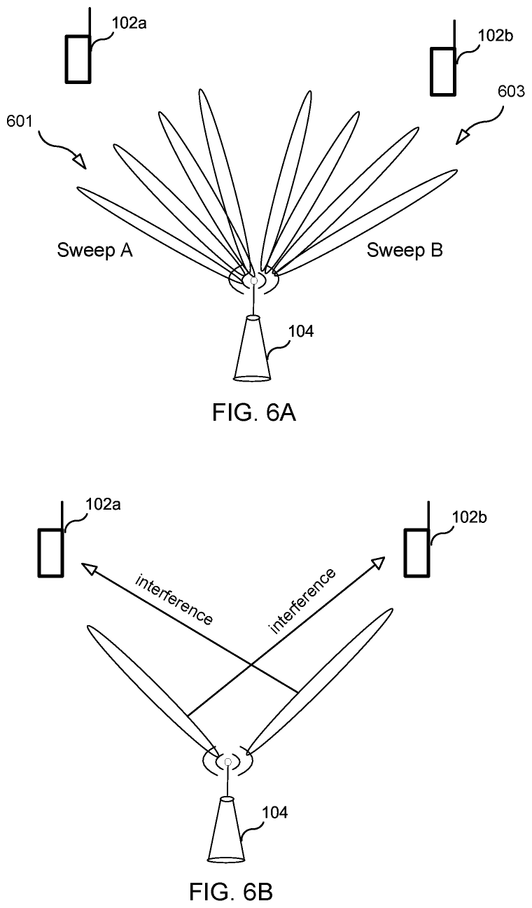

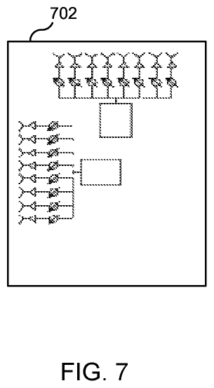

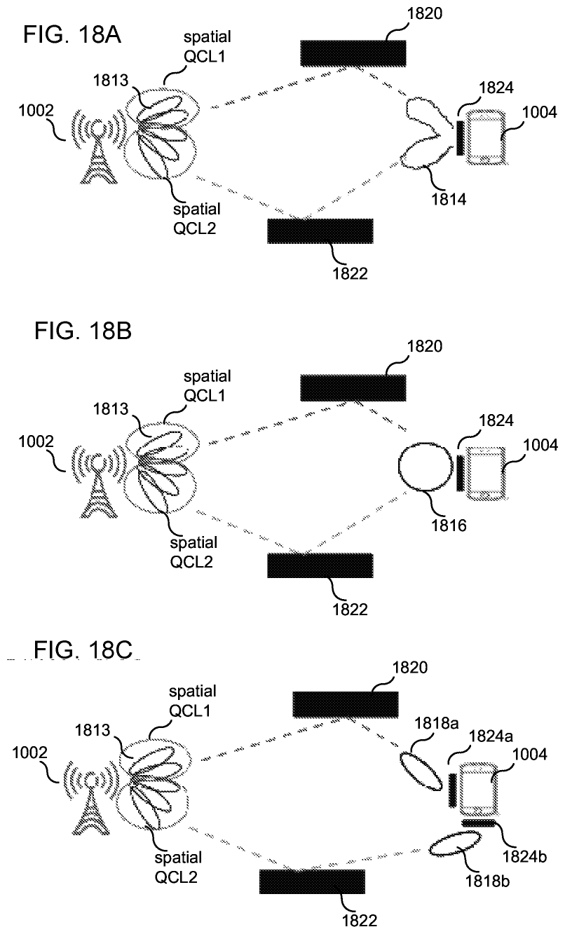

Referring now to FIGS. 18A-18C, these figures illustrate three different embodiments for how the UE 1004 may determine a suitable RX spatial filter. For instance, how the filter is determined in the case where the CSI-RS resource set used for channel measurement contains CSI-RS resources with two different spatial QCL references. In FIGS. 18A-18C, the two different spatial QCL references are identified as spatial QCL 1 and spatial QCL 2. In the non-limiting examples shown in FIGS. 18A-18C, two of the five TRP TX beams 1813 have spatial QCL 1, and three of the five TRP TX beams 1813 have spatial QCL 2. The non-limiting examples shown in FIGS. 18A-18C include walls 1820 and 1822, which cause reflection. In each embodiment, it is assumed that the UE 1004 already has determined suitable narrow beams for respective spatial QCL references (e.g., from one or more earlier UE RX beam sweeps (see FIG. 3B)).

In the embodiment shown in FIG. 18A, the UE 1004 is equipped with one UE panel 1824, and the UE 1004 may determine an RX spatial filter that generates high antenna gain in both directions indicated by the two different spatial QCL references (e.g., spatial QCL 1 and spatial QCL 2). In some non-limiting embodiments, the UE 1004 may determine an RX spatial filter that generates high antenna gain in both directions by adding the complex antenna weights for the two pre-determined narrow UE beams associated with the two spatial QCL references. For example, in some non-limiting embodiments, if the complex weights for the two pre-determined narrow UE beams are w1 and w2, the UE 1004 may determine a new complex antenna weights (w3) for the new UE beam 1814 as w3=w1+w2. Usually, with this method, the complex weights w3 of the new beam 1814 may have slightly different amplitude for the different antenna elements within the UE panel 1824, which may reduce the received power slightly. In some alternative embodiments, the UE 1004 may determine the complex antenna weights of the new UE beam 1814 by using an optimization tool that evaluates different phase settings and designs a resulting radiation pattern of the UE panel 1814 that has high gain in both directions of the two pre-determined narrow UE beams. In some embodiments, these optimized complex weights that combine multiple narrow beams could be either pre-calculated or calculated during operation. In other alternative embodiments, the UE 1004 may determine the complex antenna weights using dual-polarized beamforming, which is very flexible in generating beams with different shapes without losing much received power due to amplitude tapering.

In the embodiment shown in FIG. 18B, the UE 1004 may determine an RX spatial filter that generates a wide beam 1816 from the UE panel 1824. In some non-limiting embodiments, the wide beam 1816 may be as wide as possible for the UE panel 1824. In some embodiments, the wide beam 1816 may enable the UE 1004 to receive signals from all the directions indicated by the spatial QCL references (e.g., spatial QCL 1 and spatial QCL 2).

In the embodiment shown in FIG. 18C, the UE 1004 is equipped with multiple UE panels (e.g., UE panels 1824a and 1824b). In this case, the UE 1004 may determine an RX spatial filter that includes a first RX spatial filter for a first UE panel (e.g., UE panel 1824a) to receive signals from a first spatial QCL direction (e.g., spatial QCL1) and a second RX spatial filter for a second UE panel (e.g., UE panel 1824b) to receive signals from a second spatial QCL direction (e.g., spatial QCL2). In some embodiments, the first RX spatial filter for the first UE panel may be based only on the first spatial QCL direction (and not the second spatial QCL direction), and the second RX spatial filter for the second UE panel may be based only on the second spatial QCL direction (and not the first spatial QCL direction). In some embodiments, the UE 1004 may apply the determined RX spatial filter that includes the first RX spatial filter for the first UE panel and the second RX spatial filter for second UE panel, measure one or more CSI-RS resources associated with the first spatial QCL direction using the first UE panel and the first RX spatial filter based only on the first spatial QCL direction, and measure one or more CSI-RS resources associated with the second spatial QCL direction using the second UE panel and the second RX spatial filter based only on the second spatial QCL direction.

In some embodiments, for example as shown in FIG. 10, the UE 1004 performs the RX spatial filter determination step 1030 after the TRP 1002 triggers the beam sweep in step 1020. However, this is not required, and, in some alternative embodiments, the UE 1004 may perform the RX spatial filter determination step 1030 at a different time. For example, in some alternative embodiments, the UE 1004 may perform the RX spatial filter determination step 1030 after the TRP 1004 configures the UE 1004 with the TRP TX beam sweep in step 101 and before the TRP 1004 triggers the beam sweep in step 1020.

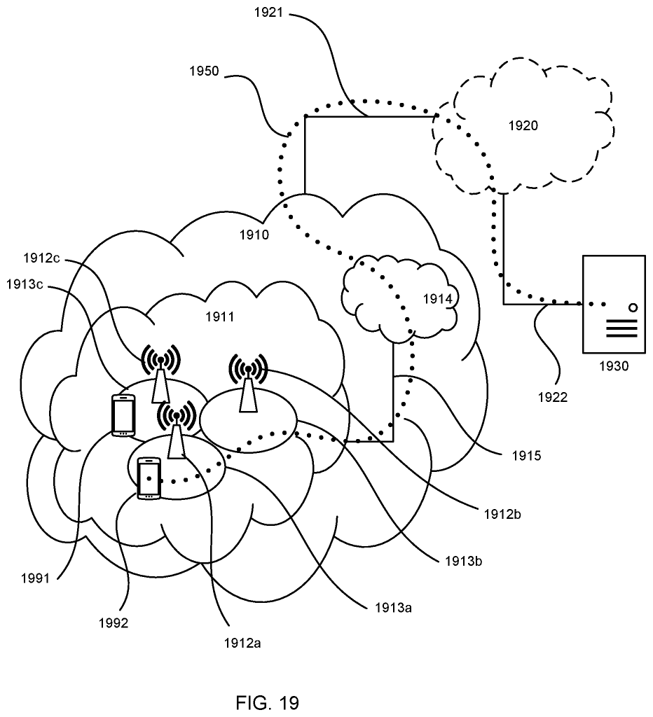

FIG. 19 illustrates a telecommunication network connected via an intermediate network to a host computer in accordance with some embodiments. With reference to FIG. 19, in accordance with an embodiment, a communication system includes telecommunication network 1910, such as a 3GPP-type cellular network, which comprises access network 1911, such as a radio access network, and core network 1914. Access network 1911 comprises a plurality of APs (hereafter base stations) 1912a, 1912b, 1912c, such as NBs, eNBs, gNBs or other types of wireless access points, each defining a corresponding coverage area 1913a, 1913b, 1913c. Each base station 1912a, 1912b, 1912c is connectable to core network 1914 over a wired or wireless connection 1915. A first UE 1991 located in coverage area 1913c is configured to wirelessly connect to, or be paged by, the corresponding base station 1912c. A second UE 1992 in coverage area 1913a is wirelessly connectable to the corresponding base station 1912a. While a plurality of UEs 1991, 1992 are illustrated in this example, the disclosed embodiments are equally applicable to a situation where a sole UE is in the coverage area or where a sole UE is connecting to the corresponding base station 1912.

Telecommunication network 1910 is itself connected to host computer 1930, which may be embodied in the hardware and/or software of a standalone server, a cloud-implemented server, a distributed server or as processing resources in a server farm. Host computer 1930 may be under the ownership or control of a service provider, or may be operated by the service provider or on behalf of the service provider. Connections 1921 and 1922 between telecommunication network 1910 and host computer 1930 may extend directly from core network 1914 to host computer 1930 or may go via an optional intermediate network 1920. Intermediate network 1920 may be one of, or a combination of more than one of, a public, private or hosted network; intermediate network 1920, if any, may be a backbone network or the Internet; in particular, intermediate network 1920 may comprise two or more sub-networks (not shown).

The communication system of FIG. 19 as a whole enables connectivity between the connected UEs 1991, 1992 and host computer 1930. The connectivity may be described as an over-the-top (OTT) connection 1950. Host computer 1930 and the connected UEs 1991, 1992 are configured to communicate data and/or signaling via OTT connection 1950, using access network 1911, core network 1914, any intermediate network 1920 and possible further infrastructure (not shown) as intermediaries. OTT connection 1950 may be transparent in the sense that the participating communication devices through which OTT connection 1950 passes are unaware of routing of uplink and downlink communications. For example, base station 1912 may not or need not be informed about the past routing of an incoming downlink communication with data originating from host computer 1930 to be forwarded (e.g., handed over) to a connected UE 1991. Similarly, base station 1912 need not be aware of the future routing of an outgoing uplink communication originating from the UE 1991 towards the host computer 1930.

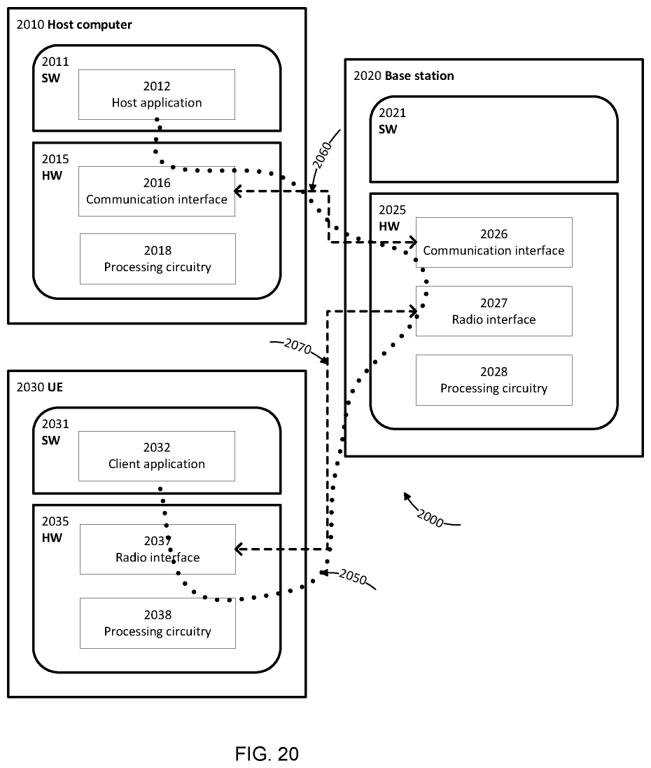

Example implementations, in accordance with an embodiment, of the UE, base station and host computer discussed in the preceding paragraphs will now be described with reference to FIG. 20, which illustrates a host computer communicating via a base station with a user equipment over a partially wireless connection in accordance with some embodiments. In communication system 2000, host computer 2010 comprises hardware 2015 including communication interface 2016 configured to set up and maintain a wired or wireless connection with an interface of a different communication device of communication system 2000. Host computer 2010 further comprises processing circuitry 2018, which may have storage and/or processing capabilities. In particular, processing circuitry 2018 may comprise one or more programmable processors, application-specific integrated circuits, field programmable gate arrays or combinations of these (not shown) adapted to execute instructions. Host computer 2010 further comprises software 2011, which is stored in or accessible by host computer 2010 and executable by processing circuitry 2018. Software 2011 includes host application 2012. Host application 2012 may be operable to provide a service to a remote user, such as UE 2030 connecting via OTT connection 2050 terminating at UE 2030 and host computer 2010. In providing the service to the remote user, host application 2012 may provide user data which is transmitted using OTT connection 2050.

Communication system 2000 further includes base station 2020 provided in a telecommunication system and comprising hardware 2025 enabling it to communicate with host computer 2010 and with UE 2030. Hardware 2025 may include communication interface 2026 for setting up and maintaining a wired or wireless connection with an interface of a different communication device of communication system 2000, as well as radio interface 2027 for setting up and maintaining at least wireless connection 2070 with UE 2030 located in a coverage area (not shown in FIG. 20) served by base station 2020. Communication interface 2026 may be configured to facilitate connection 2060 to host computer 2010. Connection 2060 may be direct or it may pass through a core network (not shown in FIG. 20) of the telecommunication system and/or through one or more intermediate networks outside the telecommunication system. In the embodiment shown, hardware 2025 of base station 2020 further includes processing circuitry 2028, which may comprise one or more programmable processors, application-specific integrated circuits, field programmable gate arrays or combinations of these (not shown) adapted to execute instructions. Base station 2020 further has software 2021 stored internally or accessible via an external connection.

Communication system 2000 further includes UE 2030 already referred to. Its hardware 2035 may include radio interface 2037 configured to set up and maintain wireless connection 2070 with a base station serving a coverage area in which UE 2030 is currently located. Hardware 2035 of UE 2030 further includes processing circuitry 2038, which may comprise one or more programmable processors, application-specific integrated circuits, field programmable gate arrays or combinations of these (not shown) adapted to execute instructions. UE 2030 further comprises software 2031, which is stored in or accessible by UE 2030 and executable by processing circuitry 2038. Software 2031 includes client application 2032. Client application 2032 may be operable to provide a service to a human or non-human user via UE 2030, with the support of host computer 2010. In host computer 2010, an executing host application 2012 may communicate with the executing client application 2032 via OTT connection 2050 terminating at UE 2030 and host computer 2010. In providing the service to the user, client application 2032 may receive request data from host application 2012 and provide user data in response to the request data. OTT connection 2050 may transfer both the request data and the user data. Client application 2032 may interact with the user to generate the user data that it provides.

It is noted that host computer 2010, base station 2020 and UE 2030 illustrated in FIG. 20 may be similar or identical to host computer 1930, one of base stations 1912a, 1912b, 1912c and one of UEs 1991, 1992 of FIG. 19, respectively. This is to say, the inner workings of these entities may be as shown in FIG. 20 and independently, the surrounding network topology may be that of FIG. 19.

In FIG. 20, OTT connection 2050 has been drawn abstractly to illustrate the communication between host computer 2010 and UE 2030 via base station 2020, without explicit reference to any intermediary devices and the precise routing of messages via these devices. Network infrastructure may determine the routing, which it may be configured to hide from UE 2030 or from the service provider operating host computer 2010, or both. While OTT connection 2050 is active, the network infrastructure may further take decisions by which it dynamically changes the routing (e.g., on the basis of load balancing consideration or reconfiguration of the network).

Wireless connection 2070 between UE 2030 and base station 2020 is in accordance with the teachings of the embodiments described throughout this disclosure. One or more of the various embodiments improve the performance of OTT services provided to UE 2030 using OTT connection 2050, in which wireless connection 2070 forms the last segment. More precisely, the teachings of these embodiments may improve one or more of the data rate, latency, block error ratio (BLER), overhead, and power consumption and thereby provide benefits such as reduced user waiting time, better responsiveness, extended battery lifetime, etc..

A measurement procedure may be provided for the purpose of monitoring data rate, latency and other factors on which the one or more embodiments improve. There may further be an optional network functionality for reconfiguring OTT connection 2050 between host computer 2010 and UE 2030, in response to variations in the measurement results. The measurement procedure and/or the network functionality for reconfiguring OTT connection 2050 may be implemented in software 2011 and hardware 2015 of host computer 2010 or in software 2031 and hardware 2035 of UE 2030, or both. In embodiments, sensors (not shown) may be deployed in or in association with communication devices through which OTT connection 2050 passes; the sensors may participate in the measurement procedure by supplying values of the monitored quantities exemplified above, or supplying values of other physical quantities from which software 2011, 2031 may compute or estimate the monitored quantities. The reconfiguring of OTT connection 2050 may include message format, retransmission settings, preferred routing etc.; the reconfiguring need not affect base station 2020, and it may be unknown or imperceptible to base station 2020. Such procedures and functionalities may be known and practiced in the art. In certain embodiments, measurements may involve proprietary UE signaling facilitating host computer 2010's measurements of throughput, propagation times, latency and the like. The measurements may be implemented in that software 2011 and 2031 causes messages to be transmitted, in particular empty or ‘dummy’ messages, using OTT connection 2050 while it monitors propagation times, errors etc.

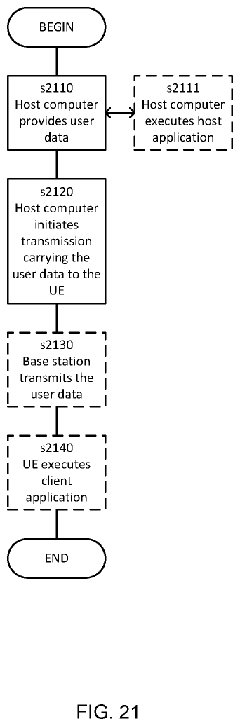

FIG. 21 is a flowchart illustrating a method implemented in a communication system, in accordance with one embodiment. The communication system includes a host computer, a base station and a UE which may be those described with reference to FIG. 19 and FIG. 20. In step S2110, the host computer provides user data. In substep S2111 (which may be optional) of step S2110, the host computer provides the user data by executing a host application. In step 52120, the host computer initiates a transmission carrying the user data to the UE. In step S2130 (which may be optional), the base station transmits to the UE the user data which was carried in the transmission that the host computer initiated, in accordance with the teachings of the embodiments described throughout this disclosure. In step S2140 (which may also be optional), the UE executes a client application associated with the host application executed by the host computer.

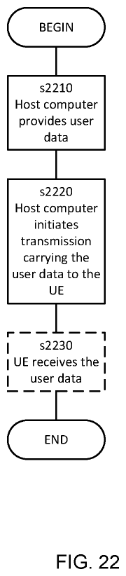

FIG. 22 is a flowchart illustrating a method implemented in a communication system, in accordance with one embodiment. The communication system includes a host computer, a base station and a UE which may be those described with reference to FIG. 19 and FIG. 20. For simplicity of the present disclosure, only drawing references to FIG. 22 will be included in this section. In step S2210 of the method, the host computer provides user data. In an optional substep (not shown) the host computer provides the user data by executing a host application. In step S2220, the host computer initiates a transmission carrying the user data to the UE. The transmission may pass via the base station, in accordance with the teachings of the embodiments described throughout this disclosure. In step S2230 (which may be optional), the UE receives the user data carried in the transmission.

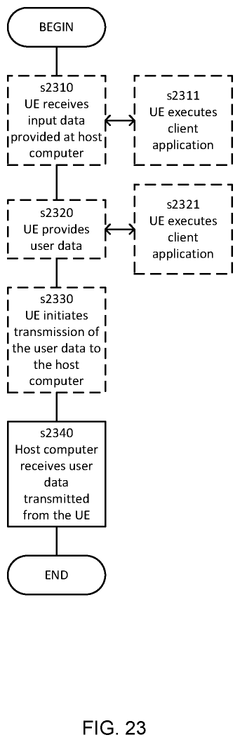

FIG. 23 is a flowchart illustrating a method implemented in a communication system, in accordance with one embodiment. The communication system includes a host computer, a base station and a UE which may be those described with reference to FIG. 19 and FIG. 20. For simplicity of the present disclosure, only drawing references to FIG. 23 will be included in this section. In step S2310 (which may be optional), the UE receives input data provided by the host computer. Additionally or alternatively, in step S2320, the UE provides user data. In substep S2321 (which may be optional) of step S2320, the UE provides the user data by executing a client application. In substep S2311 (which may be optional) of step S2310, the UE executes a client application which provides the user data in reaction to the received input data provided by the host computer. In providing the user data, the executed client application may further consider user input received from the user. Regardless of the specific manner in which the user data was provided, the UE initiates, in substep S2330 (which may be optional), transmission of the user data to the host computer. In step S2340 of the method, the host computer receives the user data transmitted from the UE, in accordance with the teachings of the embodiments described throughout this disclosure.

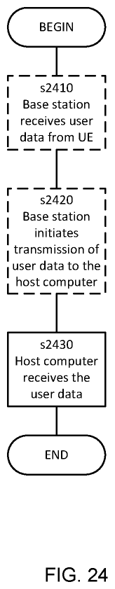

FIG. 24 is a flowchart illustrating a method implemented in a communication system, in accordance with one embodiment. The communication system includes a host computer, a base station and a UE which may be those described with reference to FIG. 19 and FIG. 20. For simplicity of the present disclosure, only drawing references to FIG. 24 will be included in this section. In step S2410 (which may be optional), in accordance with the teachings of the embodiments described throughout this disclosure, the base station receives user data from the UE. In step S2420 (which may be optional), the base station initiates transmission of the received user data to the host computer. In step S2430 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While various embodiments of the present disclosure are described herein, it should be understood that they have been presented by way of example only, and not limitation. Thus, the breadth and scope of the present disclosure should not be limited by any of the above-described exemplary embodiments. Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel. That is, the steps of any methods disclosed herein do not have to be performed in the exact order disclosed, unless a step is explicitly described as following or preceding another step and/or where it is implicit that a step must follow or precede another step.

1-71. (canceled)

72. A method performed by a user equipment (UE), the method comprising:
producing a first power value based on a reception of a channel measurement resource transmitted using a first transmit-receive point (TRP) beam;
producing a second power value based on a reception of an interference measurement resource transmitted using a second TRP beam;
determining a first throughput value using as inputs to the calculation the first and second power values; and
using the first throughput value in a process for selecting N TRP beam pairs from a set of candidate beam pairs, wherein the set of candidate beam pairs includes the first and second TRP beams, wherein N is a predetermined whole number, and wherein at least one selected TRP beam pair is a channel-interference transmit beam combination.

73. The method of claim 72, further comprising:
reporting the selected N TRP beam pairs to a node.

74. The method of claim 73, wherein the reporting comprises transmitting the corresponding throughput values for the selected N TRP beam pairs, or wherein the N TRP beam pairs are each reported using an index value.

75. The method of claim 72, wherein the selecting N TRP beam pairs comprises selecting the beam pair having the highest throughput value.

76. A computer program product comprising a non-transitory computer readable medium storing instructions which when performed by processing circuitry of a user equipment (UE) causes the UE to:
produce a first power value based on a reception of a channel measurement resource transmitted using a first transmit-receive point (TRP) beam;
produce a second power value based on a reception of an interference measurement resource transmitted using a second TRP beam;
determine a first throughput value using as inputs to the calculation the first and second power values; and
use the first throughput value in a process for selecting N TRP beam pairs from a set of candidate beam pairs, wherein the set of candidate beam pairs includes the first and second TRP beams, wherein N is a predetermined whole number, and wherein at least one selected TRP beam pair is a channel-interference transmit beam combination.

77. A user equipment (UE) comprising:
processing circuitry; and
a storage medium storing instructions that, when executed by the processing circuitry, cause the UE to:
produce a first power value based on a reception of a channel measurement resource transmitted using a first TRP beam;
produce a second power value based on a reception of an interference measurement resource transmitted using a second TRP beam;
determine a first throughput value using as inputs to the calculation the first and second power values; and
use the first throughput value in a process for selecting N TRP beam pairs from a set of candidate beam pairs, wherein the set of candidate beam pairs includes the first and second TRP beams, wherein N is a predetermined whole number, and wherein at least one selected TRP beam pair is a channel-interference transmit beam combination.

78. The UE of claim 77, wherein the processing circuitry further causes the UE to report the selected N TRP beam pairs to a node.

79. The UE of claim 78, wherein the reporting comprises transmitting the corresponding throughput values for the selected N TRP beam pairs.

80. The UE of claim 78, wherein the N TRP beam pairs are each reported using an index value.

81. The UE of claim 77, wherein the selecting N TRP beam pairs comprises selecting the beam pair having the highest throughput value.

82. The UE of claim 77, wherein the UE has at least two panels, and wherein both the first and second power values are produced based on power measurements of signals received on a first panel of the UE.

83. The UE of claim 82, wherein the processing circuitry further causes the UE to:
produce a third power value based on a reception of the channel measurement resource on a second panel of the UE; and
produce a fourth power value based on a reception of the interference measurement on the second panel of the UE,
wherein determining the first throughput value comprises determining the throughput value based on the first, second, third, and fourth power values.

84. The UE of claim 83, wherein determining the first throughput value comprises calculating a first SIR or SINR based on the first and second power values and calculating a second SIR or SINR based on the third and fourth power values..

85. The UE of claim 84, wherein the first throughput value is a weighted sum of the first and second SIRs or SINRs.

86. The UE of claim 84, wherein determining the throughput value comprises comparing the first and second SIRs or SINRs, and
wherein the first throughput value is the larger of the first and second SIRs or SINRs.

87. The UE of claim 77, wherein determining the first throughput value comprises determining a plurality of interference weights.

88. The UE of claim 87, wherein each of the interference weights has a value of 1 or 0.

89. The UE of claim 77, wherein at least one of the selected N TRP beam pairs comprises 2 transmit (TX) beams that transmitted channel measurement resources, or wherein at least one of the selected N TRP beam pairs comprises 2 TX beams that transmitted interference measurement resources.

90. The UE of claim 77, wherein N is set according to a predefined rule and wherein the rule is pre-defined in the specification, configured via RRC signaling, or determined by UE.

91. The UE claim 77, wherein one or more of the measurement resources is a channel state information reference signal, CSI-RS.

92. The UE of claim 77, wherein the processing circuitry further causes the UE to:
receiving a transmit beam sweep configuration,
wherein at least one of the producing a first power value, producing a second power value, and selecting N TRP beam pairs is based on the configuration.

93. The UE of claim 92, wherein the beam sweep configuration is defined by a CSI-AperiodicTriggerStateList information element, and
wherein the CSI-AperiodicTriggerStateList information element is configured using RRC signaling.

94. The UE of claim 92, wherein the configuration is aperiodic and the processing circuitry further causes the UE to:
receive a beam sweep trigger.

95. The UE of claim 94, wherein the receiving a beam sweep trigger comprises receiving downlink control information indicating a triggered aperiodic trigger state of a plurality of aperiodic trigger states.

96. The UE of claim 77, wherein the first and second measurement resources are received using a first receive (RX) spatial filter.

97. The UE of claim 77, wherein the processing circuitry further causes the UE to:
receive a resource set indication that indicates that a first resource set should be used by the UE for channel measurements, and a second resource sets should be used by the UE for interference measurements, and
wherein the channel measurement resources are from the first set and the interference measurement resources are from the second set.
